(19) United States
(12) Patent Application Publication
(10) Pub. No.: US 2017/0293396 A1
(43) Pub. Date: Oct. 12, 2017

(54) INFORMATION PROCESSING APPARATUS

(71) Applicant: SONY MOBILE COMMUNICATIONS INC., Tokyo (JP)

(72) Inventors: MyungJin JUNG, Kanagawa (JP); Tetsuya NARUSE, Kanagawa (JP)

(73) Assignee: SONY MOBILE COMMUNICATIONS INC., Tokyo (JP)

(21) Appl. No.: 15/448,919

(22) Filed: Mar. 3, 2017

(30) Foreign Application Priority Data
Apr. 7, 2016 (JP) 2016-076993

(51) Int. Cl. G06F 3/041; G01L 7/12

(52) U.S. Cl. CPC G06F 3/0418; G01L 7/12; G06K 9/00013

(57) ABSTRACT

There is provided an information processing apparatus including: a housing that has an inflow/outflow part through which gas flows in and out; a barometer sensor that is arranged inside of the housing and detects atmospheric pressure; and a processing unit that processes information. The processing unit senses pressing of a user on the basis of an atmospheric pressure change inside of the housing detected by the barometer sensor.

### CROSS REFERENCE TO RELATED APPLICATIONS

This application claims the benefit of Japanese Priority Patent Application JP 2016-076993 filed Apr. 7, 2016, the entire contents of which are incorporated herein by reference.

### BACKGROUND

The present disclosure relates to an information processing apparatus.

Recently, mobile terminals connectable to the Internet and the like have been propagated. Most mobile terminals are configured to perform various operations when users manipulate manipulation units included in the mobile terminals. Various manipulation units are included in a mobile terminal and the mobile terminal senses manipulations of a user on the basis of signals from various keys or sensors.

JP 2015-69225A discloses a mobile terminal including a barometer sensor. The mobile terminal disclosed in JP 2015-69225A has a housing with airtightness and the barometer sensor is arranged inside of the housing. The barometer sensor detects an atmospheric pressure variation inside of the housing and the mobile terminal changes display of a display unit on the basis of the detected atmospheric pressure variation.

### SUMMARY

In the mobile terminal disclosed in JP 2015-69225A described above, the barometer sensor is arranged in the housing having airtightness. The barometer sensor disclosed in JP 2015-69225A cannot measure outside atmospheric pressure because there is no gas inflow/outflow in the housing with airtightness. Accordingly, another barometer sensor is arranged outside the housing in order to measure outside atmospheric pressure.

Therefore, the present disclosure provides a novel and improved information processing apparatus including a barometer sensor capable of detecting atmospheric pressure inside of a housing and outside atmospheric pressure.

According to an embodiment of the present disclosure, there is provided an information processing apparatus including: a housing that has an inflow/outflow part through which gas flows in and out; a barometer sensor that is arranged inside of the housing and detects atmospheric pressure; and a processing unit that processes information. The processing unit senses pressing of a user on the basis of an atmospheric pressure change inside of the housing detected by the barometer sensor.

According to an embodiment of the present disclosure as described above, the barometer sensor may detect the atmospheric pressure inside of the housing and outside atmospheric pressure.

Note that the effects described above are not necessarily limitative. With or in the place of the above effects, there may be achieved any one of the effects described in this specification or other effects that may be grasped from this specification.

### BRIEF DESCRIPTION OF THE DRAWINGS

FIG. 1 is an illustration of an example of the exterior of a mobile terminal of an embodiment of the present disclosure;

FIG. 2 is an illustration of an example of the exterior of the mobile terminal of an embodiment of the present disclosure;

FIG. 3 is an illustration of an overview of an internal configuration of the mobile terminal of an embodiment of the present disclosure;

FIG. 4 is a block diagram illustrating an example of a configuration of the mobile terminal of an embodiment of the present disclosure;

FIG. 5 is an illustration of an example of an output value output from a barometer sensor included in the mobile terminal of an embodiment of the present disclosure;

FIG. 6 is an illustration of an example of a method for processing an output value output from the barometer sensor included in the mobile terminal of an embodiment of the present disclosure;

FIG. 7 is an illustration of a comparison between an atmospheric pressure change according to pressing of a user and an atmospheric pressure change according to another operation;

FIG. 8 is a flowchart illustrating an example of a procedure of changing the sensitivity of a touch panel using an atmospheric pressure change sensed by a processing unit on the basis of an output value of the barometer sensor; and

FIG. 9 is an illustration of an example of a manipulation pattern using an atmospheric pressure change sensed by a processing unit on the basis of an output value of the barometer sensor.

### DETAILED DESCRIPTION OF THE EMBODIMENT(S)

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Description will be given in the following order.
1. Configuration of mobile terminal
2. Example of output value output from barometer sensor and example of processing output value
3. Application examples
4. Supplement
5. Conclusion
<1. Configuration of Mobile Terminal>

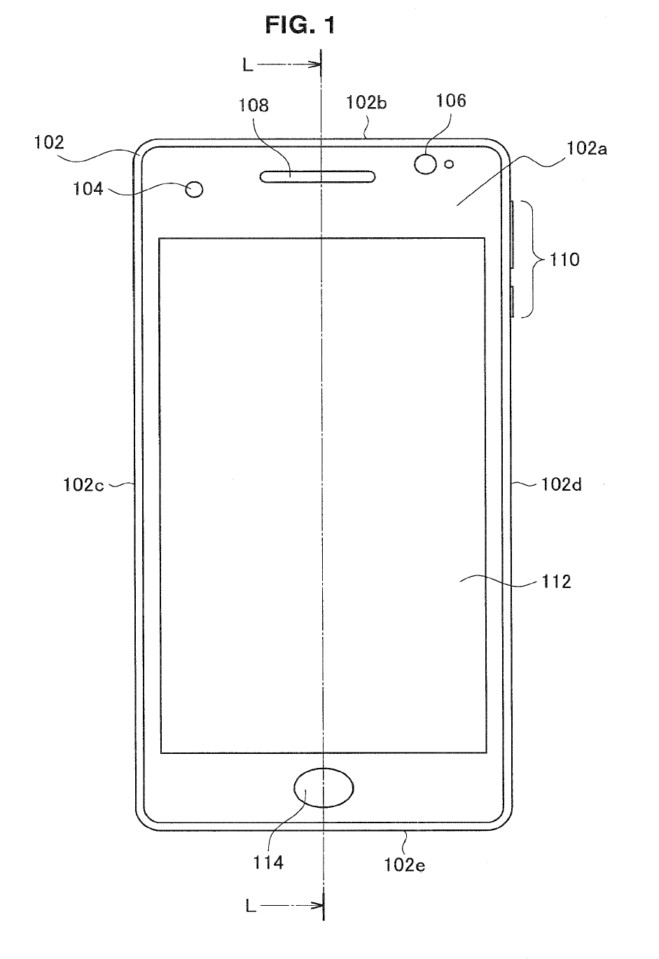

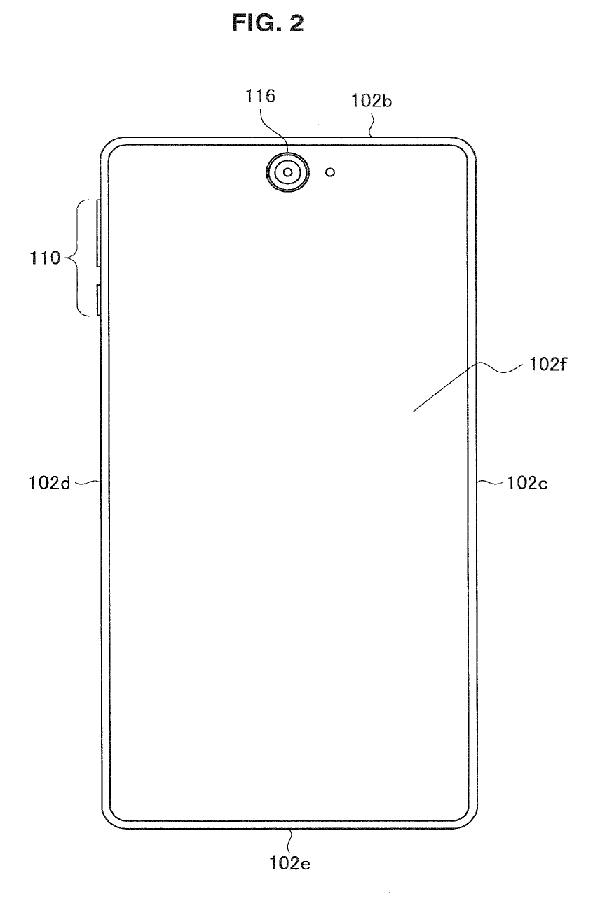

FIGS. 1 and 2 are illustrations of examples of the exterior of a mobile terminal 100 of an embodiment of the present disclosure. The mobile terminal 100 of an embodiment of the present disclosure may be a cellular phone having a call function, for example. Particularly, the mobile terminal 100 may be a smartphone capable of executing a plurality of applications. Smartphones include various applications, for example, mail, a camera, a browser, map display, music playback, video playback, short messages, etc. Further, recent smartphones include applications that require complicated processing such as games. The mobile terminal 100 of an embodiment of the present disclosure is an example of an information processing apparatus for processing information.

FIG. 1 is an illustration of the front side of the mobile terminal 100 of an embodiment of the present disclosure. In addition, FIG. 2 is an illustration of the rear side of the mobile terminal 100 of an embodiment of the present disclosure. The mobile terminal 100 of an embodiment of the present disclosure includes a housing 102, and the housing 102 includes a front side part 102a, an upper side part 102b, lateral side parts 102c and 102d, a lower side part 102e and a rear side part 102f. The components of the housing 102 may be integrally molded, or the border lines of the components may be packed using a material having plasticity, flexibility or elasticity, such as rubber, and then combined. Further, the housing 102 includes a gas inflow/outflow part through which limited gas inflow/outflow occurs as will be described below.

In addition, the mobile terminal 100 of an embodiment of the present disclosure includes a proximity sensor 104, an in-camera 106, a speaker 108, a hardware key 110, a display 112, and a fingerprint sensor 114, as illustrated in FIG. 1.

The proximity sensor 104 may sense a sensing target using infrared rays, ultrasonic waves or electromagnetic waves, for example. In addition, the proximity sensor 104 may sense a sensing target using over-current variation according to electromagnetic induction or capacitance variation according to approach of the sensing target.

The in-camera 106 includes an image sensor such as a charge-coupled device (CCD) or a complementary metal oxide semiconductor (CMOS). For example, the in-camera 106 is used when a user photographs his or her face.

The speaker 108 is used to output sounds. The speaker 108 is used to output voice of a counterpart when the call function of the mobile terminal 100 is used, for example. In addition, the speaker 108 is used to output sounds when music is played.

The hardware key 110 includes a power switch, up/down keys or the like, for example. The user may power off the mobile terminal 100 by pressing the power switch for a predetermined time, for example. In addition, the user may perform a predetermined manipulation on an application executed in the mobile terminal 100 by manipulating the up/down keys.

The display 112 is used to display images. The display 112 may be a liquid crystal display or an organic electro-luminescence display. The display 112 may include a touch panel as will be described below.

The fingerprint sensor 114 is used to recognize a fingerprint of the user. For example, the mobile terminal 100 may release lock of the mobile terminal 100 on the basis of a fingerprint recognized by the fingerprint sensor 114. The fingerprint sensor 114 includes an electrode and recognizes a fingerprint by detecting a change in charges when a user's finger is placed on the electrode.

In addition, the mobile terminal 100 includes an out-camera 116, as illustrated in FIG. 2. The out-camera 116 includes an image sensor such as a CCD or a CMOS like the in-camera 106. Further, the out-camera 116 has a larger number of image pixels than the in-camera 106. Accordingly, the out-camera 116 is used to photograph an image of a wide range such as a scenery.

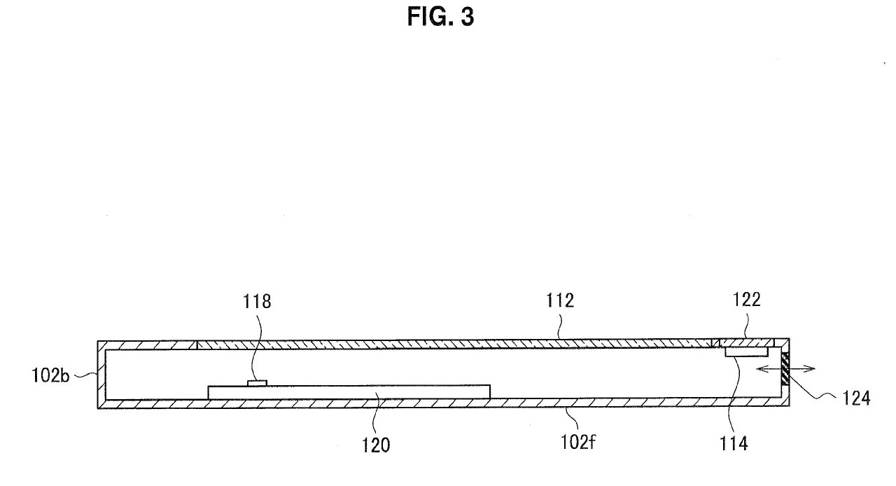

The exterior of the mobile terminal 100 and the external components thereof have been described above. Hereinafter, an internal configuration of the mobile terminal 100 will be described. FIG. 3 is an illustration of the internal configuration of the mobile terminal 100. Meanwhile, FIG. 3 is a cross-sectional view taken along line L of FIG. 1.

As illustrated in FIG. 3, the mobile terminal 100 further includes a barometer sensor 118, a circuit board 120, a transparent panel 122, and a gas inflow/outflow part 124. The barometer sensor 118 is provided on the circuit board 120 arranged inside of the housing 102. In addition, the transparent panel 122 is provided on the fingerprint sensor 114. Further, the display 112 is attached to the housing 102 using a double-sided tape or the like.

Here, gas inflow/outflow in the housing 102 will be described. As described above, the housing 102 is integrally molded or the components of the housing 102 are combined using rubber or the like without gaps. Further, the display 112 is attached to the housing 102 using a double-sided tape or the like, as described above, and no gap is generated between the housing 102 and the display 112. Accordingly, gas in the housing 102 flows into/out through the gas inflow/outflow part 124 as indicated by an arrow in FIG. 3.

The gas inflow/outflow part 124 may be configured with a waterproof air-permeable material provided in a hole formed in a part of the housing 102, for example. In addition, the gas inflow/outflow part 124 may be merely a small hole. That is, the gas inflow/outflow part 124 generates a state in which there is limited gas inflow/outflow inside of the housing 102. Further, when a waterproof air-permeable material is used for the gas inflow/outflow part 124, a state in which there is air flow in the housing 102 and no liquid flows thereinto is generated. Accordingly, waterproofness of the mobile terminal 100 may be achieved and the barometer sensor 188 may detect outside atmospheric pressure.

In FIG. 3, the gas inflow/outflow part 124 is formed at a part of the lower side part 102e of the housing 102. However, the position at which the gas inflow/outflow part 124 is formed is not limited to the illustrated position. In addition, the position at which the fingerprint sensor 114 is provided and the position at which the barometer sensor 118 is provided are not limited to the illustrated positions. As described above, the barometer sensor 118 may detect outside atmospheric pressure and atmospheric pressure inside of the housing 120 because gas flows into/out of the housing 102 through the gas inflow/outflow part 124 in the mobile terminal 100 of an embodiment of the present disclosure.

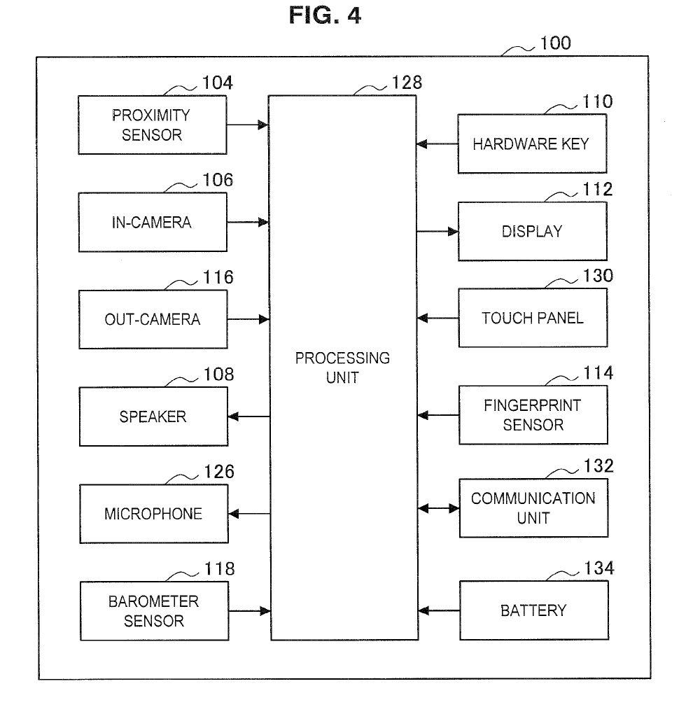

The internal configuration of the mobile terminal 100 has been described above. Hereinafter, a configuration of the mobile terminal 100 will be described. FIG. 4 is a block diagram illustrating the configuration of the mobile terminal 100. As illustrated in FIG. 4, the mobile terminal 100 further includes a microphone 126, a processing unit 128, a touch panel 130, a communication unit 132, and a battery 134.

The microphone 126 is used to receive voice in a telephone conversation and the like. The processing unit 128 processes information in cooperation with the components of the mobile terminal 100. For example, the processing unit 128 processes image information input from the in-camera 106 and the out-camera 116. In addition, the processing unit 128 senses pressing of the user on the basis of the atmospheric pressure inside of the housing 102, detected by the barometer sensor 118. Further, the processing unit 128 receives information operated by the user from the touch panel 130 and processes the information.

The touch panel 130 may be attached to the display 112 or integrated into the display 112 (e.g., in-cell type touch panel). The user may perform various manipulations on the mobile terminal 100 using the touch panel 130. For example, the user may select a display item displayed on the display 112 by pressing the touch panel 130.

Further, the communication unit 132 is used for communication with other apparatuses. For example, the communication unit 132 communicates with a base station of a mobile network and thus the mobile terminal 100 is connected to a mobile communication network, the Internet or the like. The communication unit 132 may be a wireless communication interface set in 3GPP such as Long Term Evolution (LTE). In addition, the communication unit 132 may be a short-range wireless communication interface such as Bluetooth (registered trademark). Further, the battery 134 provides power to each component and is configured to be rechargeable.
<2. Example of Output Value Output from Barometer Sensor and Example of Processing Output Value>

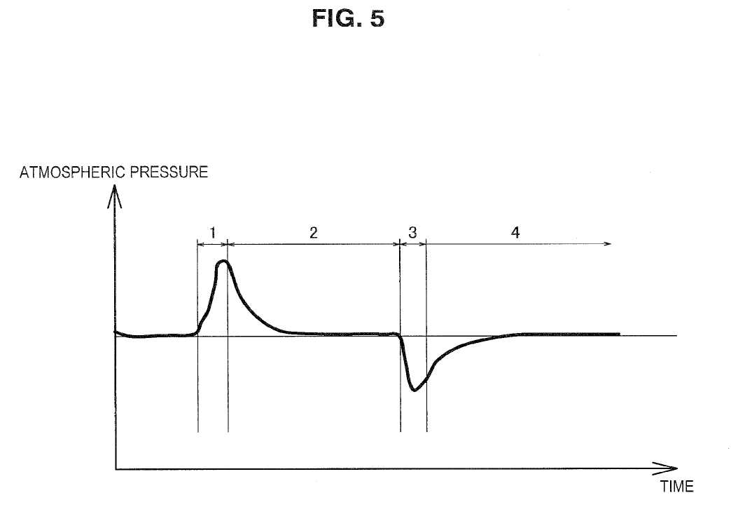

The configuration of the mobile terminal 100 has been described above. Hereinafter, an output value output from the barometer sensor 118 and an example of processing the output value will be described. FIG. 5 is an illustration of an example of an output value output from the barometer sensor 118. A change in a period indicated by “1” in FIG. 5 is a change in the atmospheric pressure inside of the housing 102 when the user presses the front side part 102a of the housing 102 of the mobile terminal 100 or a part of the mobile terminal such as the display 112 with a finger or the like. Meanwhile, a finger is an example of a sensed object and sensed objects also include a touch pen and the like.

At this time, a part of the mobile terminal 100 is deformed and thus the internal volume of the housing 102 is reduced. In addition, at this time, gas (air) inside of the housing 102 flows out through the gas inflow/outflow part 124. However, since outflow of gas through the gas inflow/outflow part 124 is limited, outflow of gas does not catch up with reduction of the volume of the housing 102 according to a part of the mobile terminal 100 pressed by the user and thus the gas inside of the housing 102 is compressed. Accordingly, the atmospheric pressure inside of the housing 102 increases and the processing unit 128 senses an atmospheric pressure change on the basis of the output value of the barometer sensor 118.

A change in a period indicated by “2” in FIG. 5 is an atmospheric pressure change inside of the housing 102 when the state in which the user presses the front side part 102a of the housing 102 of the mobile terminal 100 or a part of the mobile terminal such as the display 112 with a finger or the like is maintained. At this time, the internal volume of the housing 102 is identical to the volume in the period “1.” However, gas inside of the housing 102 continuously flows out through the gas inflow/outflow part 124 and thus the atmospheric pressure inside of the housing 102 slowly decreases. Accordingly, outflow of gas through the gas inflow/outflow part 124 is stopped when the atmospheric pressure inside of the housing 102 becomes identical to the outside atmospheric pressure.

A change in a period indicated by “3” in FIG. 5 is an atmospheric pressure change inside of the housing 102 when the user releases the finger or the like from the mobile terminal. At this time, the shape of the mobile terminal 100 returns to its original shape and the internal volume of the housing 102 also returns to the original volume. However, since inflow of gas through the gas inflow/outflow part 124 is limited, inflow of gas does not catch up with the increase in the volume of the housing 102 according to the return of the shape of the mobile terminal 100 to its original shape and thus the gas inside of the housing 102 expands. Accordingly, the atmospheric pressure inside of the housing 102 decreases and the processing unit 128 senses an atmospheric pressure change on the basis of the output value of the barometer sensor 118. In addition, in a period indicated by “4” in FIG. 5, gas flows in through the gas inflow/outflow part 124 and thus the atmospheric pressure inside of the housing 102 returns to the original atmospheric pressure. That is, the atmospheric pressure inside of the housing 102 becomes identical to outside atmospheric pressure.

The output value output from the barometer sensor 118 has been described above. Hereinafter, an example of processing the output value output from the barometer sensor 118 will be described. In the mobile terminal 100 of an embodiment of the present disclosure described above, there is limited gas inflow/outflow into/from the housing 102 through the gas inflow/outflow part 124. Since there is gas inflow/outflow into/from the housing 102, the atmospheric pressure inside of the housing 102 is identical to the outside atmospheric pressure in a state in which the user does not press a part of the mobile terminal 100 (i.e., the shape of the mobile terminal 100 is not deformed). Accordingly, if the mobile terminal 100 were in a place with a high altitude, for example, the atmospheric pressure inside of the housing 102 would decrease like the outside atmospheric pressure.

Since the atmospheric pressure inside of the housing 102 changes in response to the outside atmospheric pressure, there is a possibility of generation of a problem according to outside atmospheric pressure variation when the output value of the barometer sensor 118 is used as it is to determine that the user presses the mobile terminal 100. For example, consider a case in which the processing unit 128 determines that the user has pressed a part of the mobile terminal 100 when the atmospheric pressure detected by the barometer sensor 118 exceeds a specific threshold value. In this case, when the user does not firmly press the mobile terminal 100 when the outside atmospheric pressure is low, the processing unit 128 may not determine that the user presses the mobile terminal 100.

To prevent such a problem, a difference between the output value output from the barometer sensor 118 and a moving average of the output value output from the barometer sensor 118 is used in the mobile terminal 100 of an embodiment of the present disclosure. The moving average follows the output value of the barometer sensor 118 while being slightly delayed from the output value and smoothed. That is, because the difference between the output value of the barometer sensor 118 and the moving average of the output value is a difference between the current output value of the barometer sensor 118 and an output value slightly delayed and smoothed, the influence of the level of altitude (the level of outside atmospheric pressure) is removed.

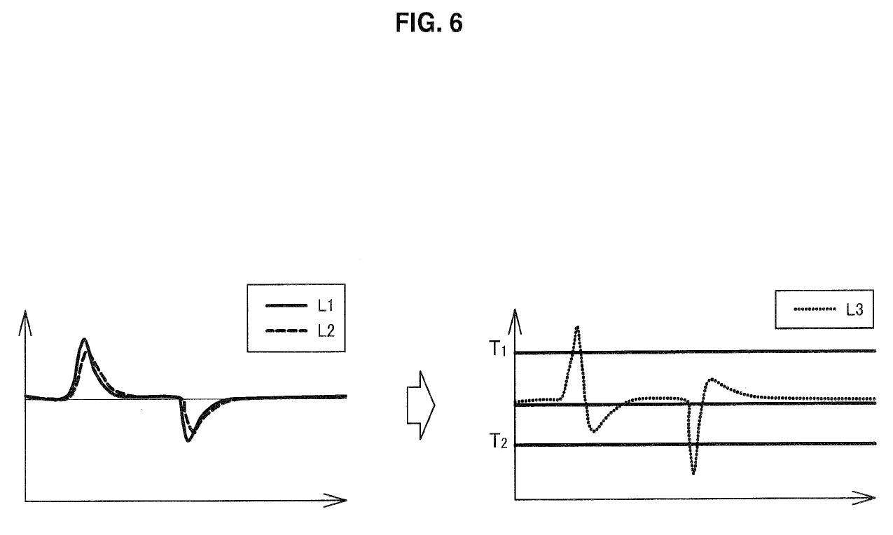

FIG. 6 is an illustration of an example of processing the output value of the barometer sensor 118 described above. A line represented by a solid line L1 on the left in FIG. 6 indicates an output value output from the barometer sensor 118. In addition, a line represented by a dashed line L2 on the left in FIG. 6 indicates a moving average calculated by applying a low pass filter to the output value output from the barometer sensor 118.

Here, the processing unit 128 calculates the moving average of the output value output from the barometer sensor 118 indicated by the dashed line L2 on the basis of the following formula.

Moving average (t)=Moving average (t−1)+k×(Output value(t)−Moving average (t−1)) (1)

Here, k may change between 0 and 1.0. Subsequently, the processing unit 128 calculates a difference between the output value of the barometer sensor 118 indicated by L1 and the moving average of the output value of the barometer sensor 118 indicated by the dashed line L2. A line represented by a dotted line L3 on the right in FIG. 6 indicates the difference between the output value of the barometer sensor 118 indicated by L1 and the moving average of the output value of the barometer sensor 118 indicated by the dashed line L2 on the left in FIG. 6. Meanwhile, in the graph shown on the right in FIG. 6, the vertical axis indicating values of atmospheric pressure is extended with respect to the graph shown on the left in FIG. 6.

Further, predetermined threshold values are set as represented by lines “T1” and “T2” on the right in FIG. 6. Here, when the line indicated by the dotted line L3 exceeds the threshold value T1, the processing unit 128 determines that the user presses a part of the mobile terminal 100. In addition, when the line indicated by the dotted line L3 is below the threshold value T2, the processing unit 128 determines that the user releases a part of the mobile terminal 100.

Further, a case in which the user presses a part of the mobile terminal 100 is discriminated from a case in which the mobile terminal 100 collides with other objects according to vibration when the mobile terminal 100 is in a bag or the like according to the aforementioned process.

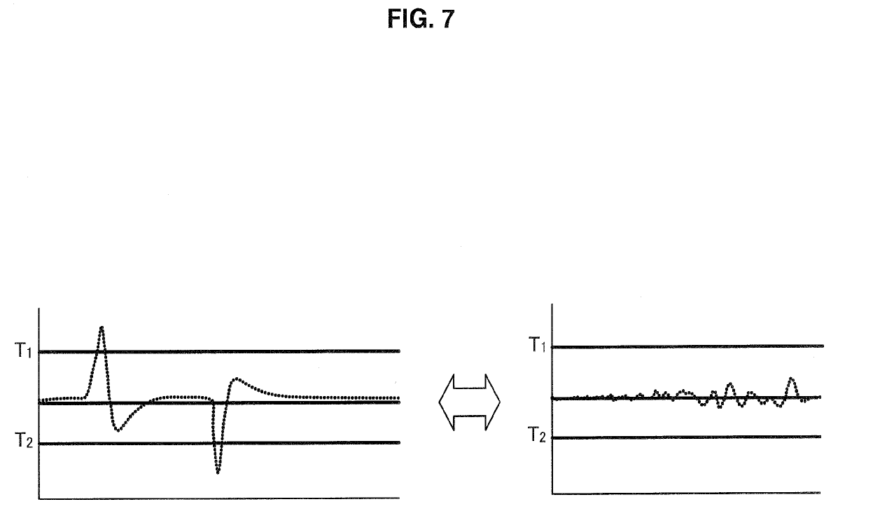

FIG. 7 is an illustration of a comparison between an atmospheric pressure change inside of the housing 102 when the user presses the mobile terminal 100 (left) and an atmospheric pressure change inside of the housing 102 when the mobile terminal 100 collides with other objects in a bag or the like (right). Meanwhile, both graphs on the left and right in FIG. 7 show output values of the barometer sensor 118 after the process described using FIG. 6 is performed.

From the comparison between the graphs on the left and right in FIG. 7, it may be seen that the change of the output value output when the user presses the mobile terminal 100 (left) is greater than the change of the output value output when the mobile terminal 100 collides with other objects in a bag or the like (right). Accordingly, as shown in FIG. 6 or 7, wrong determination is reduced by setting appropriate values as threshold values.
<3. Application Examples>

The structure of the mobile terminal 100 of an embodiment of the present disclosure, the output value of the barometer sensor 118 included in the mobile terminal 100 of an embodiment of the present disclosure and an example of processing the output value have been described above. Hereinafter, application examples using an atmospheric pressure change inside of the housing 102 sensed by the processing unit 128 on the basis of the output value of the aforementioned barometer sensor 118 will be described.

### (First Application Example)

The technology of an embodiment of the present disclosure may be used to generate a start signal for starting the mobile terminal 100 from a sleep state. That is, when the user presses a part of the mobile terminal 100, the processing unit 128 senses an atmospheric pressure change inside of the housing 102 on the basis of the output value of the barometer sensor 118 and generates a start signal. Accordingly, when the mobile terminal 100 includes the fingerprint sensor 114 as illustrated in FIGS. 1 and 3, for example, the user may start the mobile terminal 100 by pressing the mobile terminal 100 on the fingerprint sensor 114 and perform fingerprint authentication using the fingerprint sensor 114. That is, the user may easily perform starting of the mobile terminal 100 and fingerprint authentication through a single operation without starting the mobile terminal 100 from a sleep state by operating other manipulation units.

### (Second Application Example)

In addition, the technology of an embodiment of the present disclosure may be used to adjust the sensitivity of the touch panel 130 included in the mobile terminal 100. When a person's fingers are dry or a user is wearing gloves, a response of the touch panel 130 generally deteriorates. When the response of the touch panel 130 deteriorates, a user firmly presses the screen (i.e., the touch panel 130) in general. Accordingly, when the atmospheric pressure change inside of the housing 102 based on the difference between the output value of the barometer sensor 118 and the moving average described in FIG. 6 increases, the processing unit 128 of the mobile terminal 100 of an embodiment of the present disclosure performs a procedure for increasing the sensitivity of the touch panel 130.

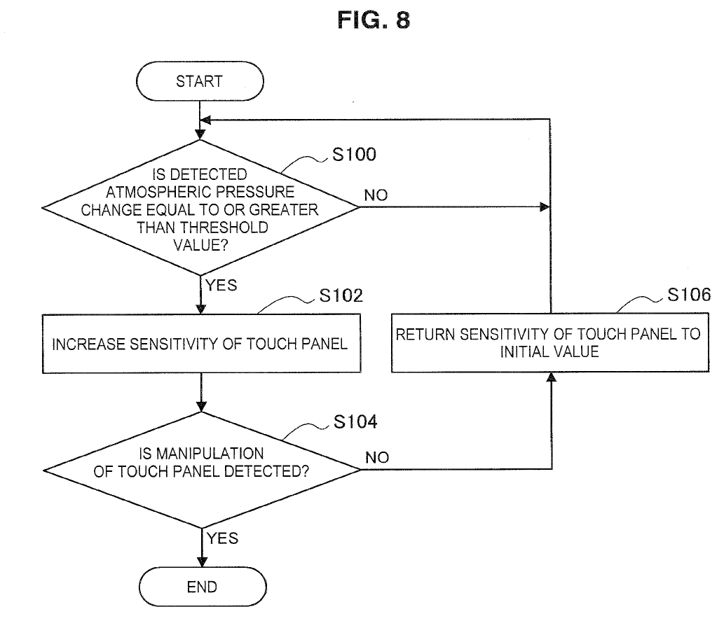

FIG. 8 is a flowchart illustrating the aforementioned procedure. Initially, the processing unit 128 determines whether an atmospheric pressure change inside of the housing 102 based on an output value of the barometer sensor 118 is equal to or greater than a predetermined threshold value in S100. When the atmospheric pressure change inside of the housing 102 based on the output value of the barometer sensor 118 does not exceed the predetermined threshold value in S100, the procedure repeats the determination of S100.

When the processing unit 128 determines that the atmospheric pressure change inside of the housing 102 based on the output value of the barometer sensor 118 is equal to or greater than the predetermined threshold value in S100, the procedure proceeds to S102. The fact that the atmospheric pressure change inside of the housing 102 based on the output value of the barometer sensor 118 is equal to or greater than the predetermined threshold value means that the user firmly presses the screen because the response of the touch panel 130 deteriorates. Accordingly, the processing unit 128 increases the sensitivity of the touch panel 130 in S102.

Then, the procedure proceeds to S104 in which the processing unit 128 determines whether manipulation of the touch panel 130 has been detected. When the processing unit 128 detects manipulation of the touch panel 130 in S104, the procedure is finished. However, when the processing unit 128 does not detect manipulation of the touch panel 130 in S104, the procedure proceeds to S106.

In S106, the processing unit 128 returns the sensitivity of the touch panel 130 to an initial value. Then, the procedure returns to S100. When the processing unit 128 determines again that an atmospheric pressure change inside of the housing 102 based on an output value of the barometer sensor 118 is equal to or greater than the predetermined threshold value in S100, the procedure proceeds to S102 again. The processing unit 128 sets the sensitivity of the touch panel 130 to be higher than the previously set sensitivity of the touch panel 130.

Then, the procedure proceeds to S104 in which the processing unit 128 determines whether manipulation of the touch panel 130 has been detected. When the processing unit 128 has detected manipulation of the touch panel 130 in S104, the procedure is finished. However, when the processing unit 128 has not detected manipulation of the touch panel 130 again in S104, the procedure proceeds to S106 and the processes of S100 to S106 are repeated.

As described above, the user may perform manipulation using the touch panel 130 with appropriate force according to adjustment of the sensitivity of the touch panel 130 using an atmospheric pressure change inside of the housing 102 based on an output value of the barometer sensor 118. Meanwhile, the difference between the output value of the barometer sensor 118 and the moving average described in FIG. 6 has been used as a value used for determination in the aforementioned example. However, an atmospheric pressure change inside of the housing 102 based on the output value itself of the barometer sensor 118 may be used for determination.

### (Third Application Example)

The mobile terminal 100 has a mode in which the user sets a manipulation pattern for performing a predetermined operation and performs the predetermined operation by reproducing the set predetermined manipulation pattern. Here, the manipulation pattern for the predetermined operation includes a manipulation pattern for releasing lock of the screen, for example.

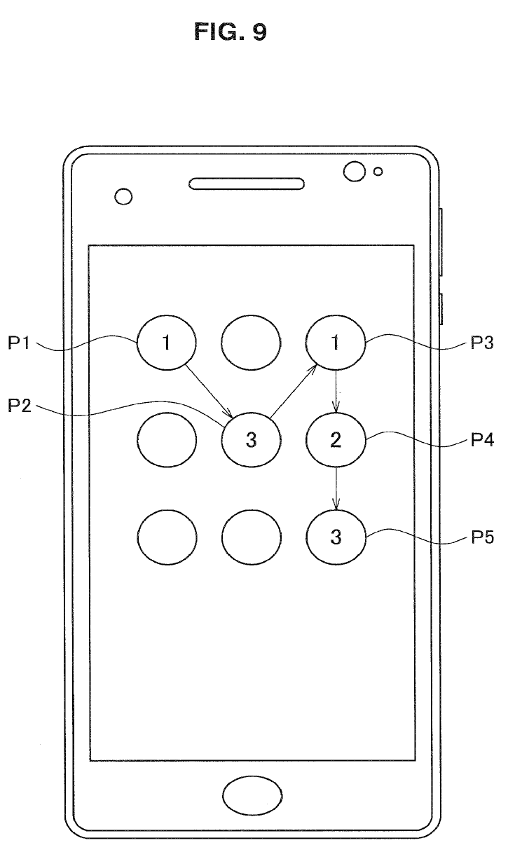

FIG. 9 is an illustration of an application example in which the technology of an embodiment of the present disclosure is applied to a manipulation pattern for releasing lock of the screen. When the lock of the screen is released, the user may set the manipulation pattern by setting an order in which nine symbols displayed on the display 112 are traced, for example. In an embodiment of the present disclosure, the intensity with which the symbols are pressed is set in addition to the order in which the symbols are traced.

For example, when the manipulation pattern is set such that symbols are traced in the order of P1 to P5, as illustrated in FIG. 9, the intensity with which the symbols P1 to P5 are pressed is also set. In FIG. 9, the user presses P1 with an intensity of “1,” presses P2 with an intensity of “3,” presses P3 with an intensity of “1,” presses P4 with an intensity of “2” and presses P3 with an intensity of “3.”

In the above-described example, the intensity with which the user presses the screen is indicated in 3 levels. However, the intensity is not limited to 3 levels and may be 1 level (that is, whether to press or not) or more than 3 levels.

In this manner, the user may set a manipulation pattern more complicatedly by setting the intensity with which the symbols are pressed in addition to the order in which the symbols are traced. This is very effective for operations related to security such as release of a locked screen in the mobile terminal 100. Particularly, the order in which the symbols are traced is seen by other persons from the outside and thus the manipulation pattern may be recognized by such persons. On the other hand, the intensity with which the symbols are pressed is difficult to recognize by other persons from the outside, and thus security is more improved.

### (Other Application Examples)

The technology of an embodiment of the present disclosure may be used for character input in the mobile terminal 100. For example, when the user inputs characters, the user may input capital letters by pressing a part of the mobile terminal 100. Accordingly, the user may easily input characters without switching character input. In addition, when the user inputs a password and the like, for example, security may be more improved. Further, input characters may be capital letters while displayed characters are small letters. Accordingly, security is improved. Meanwhile, while the above-described example is an example of switching small letters and capital letters, the example is not limited thereto. For example, alphabetic characters and numerals may be switched. That is, the user presses the mobile terminal 100 to switch input letters.

In addition, the technology of an embodiment of the present disclosure may be used for manipulation in applications. For example, when the user presses the mobile terminal 100 in a camera application, a still image capture mode and a moving image capture mode are switched.

Furthermore, when the user presses the mobile terminal 100 in a music playback application, music playback is stopped. Further, when the user continuously presses the mobile terminal 100, music playback may be fast forwarded. In addition, in a game application, a motion of a character may be changed in response to the intensity of pressing the mobile terminal 100 by the user. For example, the intensity of pressing the mobile terminal 100 by the user may be converted into the height of jump of a character of a game application.

Moreover, the technology of an embodiment of the present disclosure may be used for mode change depending on the altitude at which the mobile terminal 100 is present. As described above, the mobile terminal 100 of an embodiment of the present disclosure may detect outside atmospheric pressure with the barometer sensor 118. Accordingly, modes may be changed between a place where outside atmospheric pressure is low (i.e., altitude is high) and a place where outside atmospheric pressure is high (i.e., altitude is low). For example, because the user performs photography in a wide angle mode in many cases (in order to photograph a wide scenery) in a high-altitude place, the mode may switch to the wide angle mode when the barometer sensor 118 detects a low atmospheric pressure. Further, when the barometer sensor 118 senses a low atmospheric pressure and thus determines that it is in-flight, the mode may switch to an airplane mode.
<4. Supplement>

It should be understood by those skilled in the art that various modifications, combinations, sub-combinations and alterations may occur depending on design requirements and other factors insofar as they are within the scope of the appended claims or the equivalents thereof.

For example, for sensing pressing of the user by the processing unit 128 on the basis of the output value of the barometer sensor 118, machine learning may be used. Accordingly, wrong detection may be further prevented. This is effective when the gas inflow/outflow part 124 is deteriorated and there is a change in gas inflow/outflow into/from the housing 102. In addition, wrong detection according to an individual difference of the mobile terminal 100 is reduced according to machine learning. Further, propriety of pressing of the user used for machine learning may be determined by deciding whether decision of pressing is proper according to feedback from the user or may be determined on the basis of some manipulation signals sensed by the processing unit 128.

Further, the mobile terminal 100 may be a wrist watch type or wrist band type wearable terminal. In the case of such a small terminal, a volume for arranging components inside of the mobile terminal 100 is small. Accordingly, detection of outside atmospheric pressure and atmospheric pressure inside of the housing using the single barometer sensor 118, as in the mobile terminal 100 of an embodiment of the present disclosure, is very useful because the number of components decreases.

In addition, a computer program for causing the processing unit 128 to operate as described above may be provided. Further, a storage medium storing such a program may be provided.
<5. Conclusion>

As described above, in the mobile terminal 100 of an embodiment of the present disclosure, pressing of the user is sensed on the basis of the atmospheric pressure inside of the housing 102 detected by the barometer sensor 118. Further, gas inflow/outflow into/from the housing 102 through the gas inflow/outflow part 124 is possible in the mobile terminal 100 of an embodiment of the present disclosure. Accordingly, the mobile terminal 100 of an embodiment of the present disclosure may sense the outside atmospheric pressure in addition to pressing of the user. Therefore, adjustment of the sensitivity of the touch panel 130, switching of manipulations in applications and the like are easily performed.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1) An information processing apparatus including:
   a housing that has an inflow/outflow part through which gas flows in and out;
   a barometer sensor that is arranged inside of the housing and detects atmospheric pressure; and
   a processing unit that processes information,
   wherein the processing unit senses pressing of a user on the basis of an atmospheric pressure change inside of the housing detected by the barometer sensor.
(2) The information processing apparatus according to (1), wherein the inflow/outflow part includes a restriction member that restricts inflow/outflow of gas.
(3) The information processing apparatus according to (1) or (2), wherein the processing unit senses release of a sensed object by the user on the basis of the atmospheric pressure change inside of the housing detected by the barometer sensor.
(4) The information processing apparatus according to any one of (1) to (3), wherein the processing unit calculates a difference between an output value of the barometer sensor and a moving average of the output value of the barometer sensor as quantity of the atmospheric pressure change, and
   the processing unit senses pressing of the user on the basis of a comparison between the calculated quantity of the atmospheric pressure change and a threshold value.
(5) The information processing apparatus according to any one of (1) to (4), further including:
   a touch panel,
   wherein the processing unit changes sensitivity of the touch panel on the basis of magnitude of an atmospheric pressure change inside of the housing sensed by the barometer sensor.
(6) The information processing apparatus according to (5), wherein the processing unit recognizes a pattern for performing a predetermined operation on the basis of a position of a sensed object detected by the touch panel and the atmospheric pressure change sensed by the barometer sensor.
(7) The information processing apparatus according to any one of (1) to (6), further including:
   a fingerprint sensor,
   wherein the processing unit performs recognition of a fingerprint using the fingerprint sensor when pressing of the user is sensed on the basis of the atmospheric pressure change detected by the barometer sensor.
(8) The information processing apparatus according to any one of (1) to (7), wherein the processing unit changes manipulation in an application in accordance with an atmospheric pressure change sensed by the barometer sensor.
(9) The information processing apparatus according to any one of (1) to (8), wherein the processing unit changes an input character on the basis of magnitude of an atmospheric pressure change sensed by the barometer sensor.
(10) The information processing apparatus according to any one of (1) to (9), wherein the processing unit uses machine learning to recognize pressing of the user based on the atmospheric pressure change detected by the barometer sensor.

What is claimed is:

1. An information processing apparatus comprising:
a housing that has an inflow/outflow part through which gas flows in and out;
a barometer sensor that is arranged inside of the housing and detects atmospheric pressure; and
a processing unit that processes information,
wherein the processing unit senses pressing of a user on the basis of an atmospheric pressure change inside of the housing detected by the barometer sensor.

2. The information processing apparatus according to claim 1, wherein the inflow/outflow part includes a restriction member that restricts inflow/outflow of gas.

3. The information processing apparatus according to claim 1, wherein the processing unit senses release of a sensed object by the user on the basis of the atmospheric pressure change inside of the housing detected by the barometer sensor.

4. The information processing apparatus according to claim 1, wherein the processing unit calculates a difference between an output value of the barometer sensor and a moving average of the output value of the barometer sensor as quantity of the atmospheric pressure change, and
the processing unit senses pressing of the user on the basis of a comparison between the calculated quantity of the atmospheric pressure change and a threshold value.

5. The information processing apparatus according to claim 1, further comprising:
a touch panel,
wherein the processing unit changes sensitivity of the touch panel on the basis of magnitude of an atmospheric pressure change inside of the housing sensed by the barometer sensor.

6. The information processing apparatus according to claim 5, wherein the processing unit recognizes a pattern for performing a predetermined operation on the basis of a position of a sensed object detected by the touch panel and the atmospheric pressure change sensed by the barometer sensor.

7. The information processing apparatus according to claim 1, further comprising:
a fingerprint sensor,
wherein the processing unit performs recognition of a fingerprint using the fingerprint sensor when pressing of the user is sensed on the basis of the atmospheric pressure change detected by the barometer sensor.

8. The information processing apparatus according to claim 1, wherein the processing unit changes manipulation in an application in accordance with an atmospheric pressure change sensed by the barometer sensor.

9. The information processing apparatus according to claim 1, wherein the processing unit changes an input character on the basis of magnitude of an atmospheric pressure change sensed by the barometer sensor.

10. The information processing apparatus according to claim 1, wherein the processing unit uses machine learning to recognize pressing of the user based on the atmospheric pressure change detected by the barometer sensor.
